(19) United States
(12) Patent Application Publication
(10) Pub. No.: US 2015/0006433 A1
(43) Pub. Date: Jan. 1, 2015

(54) Resource Allocation Based on Available Predictions

(71) Applicant: C4CAST.COM, INC., (US)

(72) Inventors: Gordon Michael Phillips, Pasadena, CA (US); James Tzeh-min Chong, Montrose, CA (US); Sarah Joy Underwood, Glendora, CA (US); Sean Christopher Chasworth, Monrovia, CA (US); Kenneth Michael Leslie, Pasadena, CA (US); William Palmer Jennings, JR., Simi Valley, CA (US)

(73) Assignee: C4CAST.COM, INC., Pasadena, CA (US)

(21) Appl. No.: 13/841,062

(22) Filed: Mar. 15, 2013

(51) Int. Cl. G06Q 40/06

(52) U.S. Cl. CPC G06Q 40/06
USPC 705/36 R

(57) ABSTRACT

Provided are systems, methods and techniques for facilitating allocation of resources based on available data estimates, using steps to: input a set of predictor variables and data values pertaining to them; generate a first transfer function that maps values for the predictor variables to values for a predefined set of factor variables; generate distribution information for the predictor variables based on the input data values; conduct a simulation using the distribution information for the predictor variables; map the simulated values for the predictor variables to information regarding the factor variables, using the first transfer function; map such information to estimation information for a set of target variables using a second transfer function; and display the estimation information, use the estimation information to recommend a purchase or sale of an asset, and/or directly purchase and/or sell an asset based on the estimation information.

### FIELD OF THE INVENTION

The present invention pertains, among other things, to systems, methods and techniques for allocating financial and other resources in an efficient manner using available data estimates.

### BACKGROUND

There currently exist many different techniques for allocating resources. However, most of such techniques do not adequately take into account all the information that currently is available, particularly subjective or intuitive information held by different individuals. The present inventors have discovered that some of the reasons for this failure include the near limitless variety of different kinds of such information that might be available at any given time, as well as the corresponding difficulty in creating a system that can accommodate so many different kinds of input.

Attribution analysis refers to a body of literature and practice which attributes the performance of a portfolio to individual characteristics, in order to distinguish the effects of the portfolio's passive construction (e.g., buy and hold) from active management (e.g., buying and selling, rebalancing over time) of the portfolio. Such analysis is important for identifying good asset managers who, e.g., are capable of more consistently allocating assets to their most productive uses. A “holdings-based” attribution analysis is described in “Equity Performance Attribution Methodology”, Morningstar Methodology Paper, Dec. 5, 2008, and an extension of that methodology is described in Hsu et al, “Performance Attribution: Measuring Dynamic Allocation Skill”, Financial Analysts Journal, vol. 66 no. 6, 2010. Another approach is described in Paul D. Kaplan, “Holdings-Based and Returns-Based Style Models”, Morningstar working paper, 2003. Unfortunately, the present inventors have discovered that each of these approaches has its own shortcomings, such as problems arising from classification errors in the holdings-based approach and over-emphasis on short-term results in the returns-based approach.

### SUMMARY OF THE INVENTION

The present invention addresses the foregoing resource-allocation problem by, among other things, providing systems, apparatuses, methods and techniques that use simulation in combination with a two-stage mapping approach.

Thus, one embodiment of the invention is directed to a system for facilitating allocation of resources based on available data estimates. The system includes: a processor for executing stored computer-executable process steps; and a data storage device coupled to the processor and storing said process steps. The process steps include steps to: (a) input a set of predictor variables; (b) input data values pertaining to the predictor variables, including estimated values for the predictor variables; (c) generate a first transfer function that maps values for the predictor variables to values for a predefined set of factor variables, based on historical values for the predictor variables and historical values for the factor variables; (d) generate distribution information for the predictor variables based on the input data values; (e) conduct a simulation using the distribution information for the predictor variables in order to obtain simulated values for the predictor variables; (f) map the simulated values for the predictor variables to information regarding the factor variables, using the first transfer function; (g) map the information regarding the factor variables to estimation information for a set of target variables using a second transfer function; and (h) directly display the estimation information, use the estimation information to recommend a purchase or sale of an asset, or directly purchase and/or sell an asset based on the estimation information.

The foregoing summary is intended merely to provide a brief description of certain aspects of the invention. A more complete understanding of the invention can be obtained by referring to the claims and the following detailed description of the preferred embodiments in connection with the accompanying figures.

### BRIEF DESCRIPTION OF THE DRAWINGS

In the following disclosure, the invention is described with reference to the attached drawings. However, it should be understood that the drawings merely depict certain representative and/or exemplary embodiments and features of the present invention and are not intended to limit the scope of the invention in any manner. The following is a brief description of each of the attached drawings.

FIG. 1 is a block diagram of a system according to a representative embodiment of the present invention.

FIG. 2 is a simplified block diagram of a hosting server.

FIG. 3 is a conceptual diagram illustrating generation of information regarding different sets of target variables using scenario simulation and multi-step mapping.

FIG. 4 is a flow diagram of a process involving scenario simulation and multi-step mapping.

FIG. 5 is a block diagram illustrating the components of attribution analysis, together with their relationships, according to a representative embodiment of the present invention.

FIG. 6 is a flow diagram illustrating representative attribution-based processing for resource management.

### DESCRIPTION OF THE PREFERRED EMBODIMENT(S)

The present invention provides a variety of systems, methods and techniques for use in efficiently allocating resources, such as the allocation of financial resources in connection with the purchasing, selling and otherwise managing various kinds of assets. Such resource allocation can be beneficial to individuals, organizations and institutions, as well as to larger financial and/or economic systems.

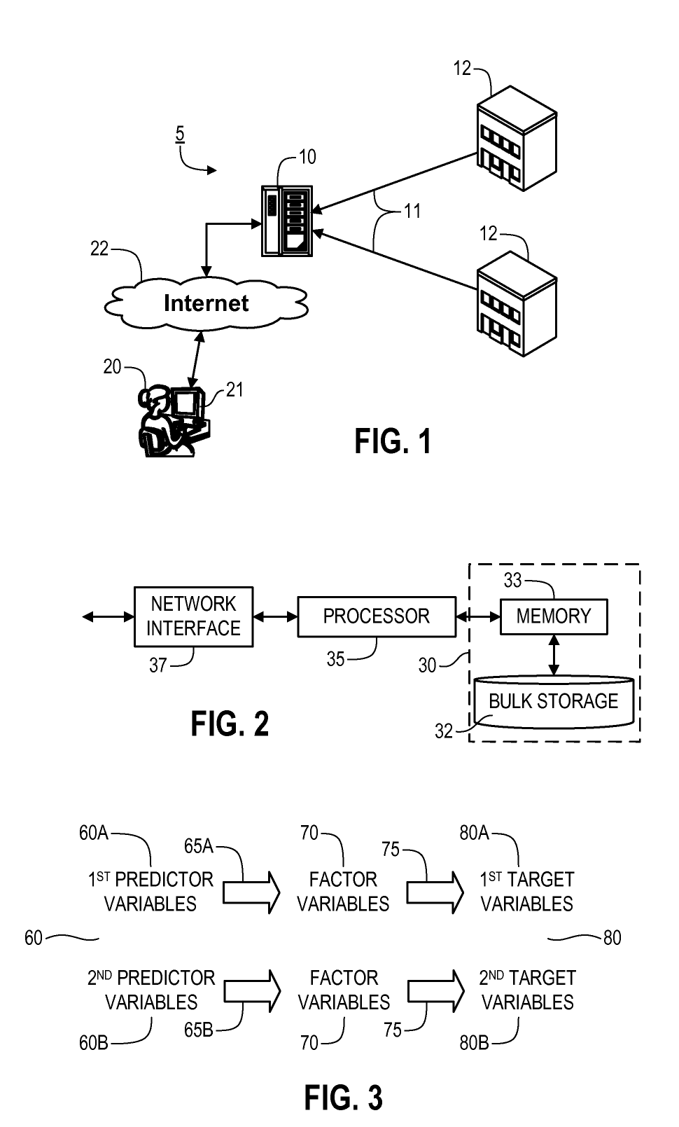

FIG. 1 illustrates a representative system 5 in which a hosting server 10 implements (or at least provides computer-executable process steps for implementing) most, all, or substantially all of the process steps and functionality described herein. For that purpose, server 10 has access to historical data values 11 for a wide variety of different variables, preferably provided by one or more different data-aggregation institutions 12. More preferably, such data values 11 are continually updated by institutions 12 and transferred on a periodic basis (e.g., via the Internet) to server 10. Such variables can include, e.g., any conceivable financial or economic variables, such as specific: stock prices, commodity prices, interest rates, monetary exchange rates, unemployment rates, index values, debt levels, production figures, spending figures, GDP, tax rates, or any of the other variables mentioned herein or in any of the documents incorporated herein by reference. In addition, such variables can include other kinds of variables, particularly variables that have some statistical correlation with financial and/or economic data, such as variables whose data values pertain to natural resources, environmental conditions, social factors, scientific developments, technological advances, product availability, weather, climate, politics, governmental policies, demographics, lifestyles, preferences and/or attitudes. Except to the extent specifically stated otherwise, any of the kinds of variables mentioned herein can be any of the types noted herein.

As discussed in greater detail below, such data values 11 preferably are processed using the methods described herein, often based on directions provided by users 20, and then the results are delivered to such users 20 to assist them in making financial and/or other resource-allocation decisions and/or provided to other automated processes that directly manage and/or allocate resources, e.g., by deciding which assets to purchase and which assets to sell. In the former case, system 5 (and in particular server 10, either alone or in coordination with the user's device 21) functions as a tool, synthesizing and qualitatively transforming a great deal of data into a relatively few easy-to-understand metrics that can simplify a user's decision-making process. In the latter case, system 5 often can automatically allocate resources in a more efficient manner and, thereby, create significant value for the users 20 and, by extension, society as a whole.

In the preferred embodiments, users 20 interact with server 10 through their respective computers or other typically programmable user devices 21 via the Internet 22. However, in alternate embodiments, any other kind of network or connection instead (or in addition) can be used for such communications, and it should be understood that any reference to the Internet herein can be replaced with references to any other network, combination of networks or other data connection. Although just a single user 20 is shown in FIG. 1, typically there will be more than 10, 25, 50, 100, 200, 500 or 1,000 users 20, connecting to server 10 at any given time, using the tools provided by server 10 for the individual's own specific purposes.

The main components of an exemplary server 10 are shown in FIG. 2. One or more storage devices 30 (typically consisting of a hard drive or other bulk storage 32 and memory 33) store data and computer-executable process steps. Processor 35 executes such steps (typically from memory 33 after having been downloaded from bulk storage 32) and communicates with users 20 and institutions 12 via network interface 37. User devices 21 (e.g., desktop computers, laptops, tablets, smartphones, etc.) typically also have the same basic configuration shown in FIG. 2, but less processing power and storage capacity. Most of the methods described herein are executed primarily by the server 10. However, in certain embodiments, server 10 downloads some of the executable process steps discussed herein (or parts of such process steps) to the user's device 21 to be executed by its processor, e.g., in order to reduce data transmissions back and forth or to reduce the processing load on server 10.

The discussions herein build on the disclosures of U.S. patent application Ser. No. 09/392,361 (now U.S. Pat. No. 6,473,084, sometimes referred to herein as the '084 patent), U.S. patent application Ser. No. 09/615,025 (now U.S. Pat. No. 6,907,403, sometimes referred to herein as the '403 patent); U.S. patent application Ser. No. 09/692,748 (now U.S. Pat. No. 7,337,135, sometimes referred to herein as the '135 patent); U.S. patent application Ser. No. 09/392,106 (now U.S. Pat. No. 7,072,863, sometimes referred to herein as the '863 patent); U.S. patent application Ser. No. 10/931,697 (now U.S. Pat. No. 7,383,219, sometimes referred to herein as the '219 patent); and U.S. patent application Ser. No. 10/931,675 (now U.S. Pat. No. 8,306,891, sometimes referred to herein as the '891 patent). Each of the foregoing patent applications is hereby incorporated by reference herein as though set forth herein in full.

The '891 patent discusses, among other things, techniques using a set of factors (or factor variables), which preferably correspond to different types of risk. A set of such factor variables and, more preferably, the set of 18 specific factor variables identified in the '891 patent, preferably also is used in the techniques of the present invention.

In the various embodiments disclosed in the '891 patent, these factor variables are used to estimate, e.g.: monetary prices and/or values for different types of financial assets, a set of ETA® values (each indicating a measure of the tendency of the monetary value of the subject financial asset to change based on a change in the data value for the corresponding factor), the statistical significance of each calculated ETA® value, and the composite risk associated with the financial asset.

The present invention generally can be divided into two main categories. For ease of reference, the present disclosure is divided into sections, with one section for each such category, as indicated by that section's heading.

Scenario Simulation with Multi-Step Mapping.

FIG. 3 illustrates the basic concept of a tool that uses scenario simulation and multi-step mapping according to the preferred embodiments of the present invention. One aspect of the present invention is the ability of a user 20 to select a set of “predictor variables” 60 (e.g., sets 60A and 60B of predictor variables 60) and specify values for (and/or in relation to) them. Preferably, those specified values mainly or exclusively our estimates of what the user 20 believes the data values for the predictor variables will be (or are or were) at a specific point in time. In the preferred embodiments, the user 20 can more or less arbitrarily select the desired predictor variables 60 to be used from a larger set of available predictor variables, although in most cases they are limited to choosing from the larger set of predictor variables for which server 10 has access to historical data values 11. Also, as noted below, the selection of the predictor variables 60 and the assignment of data values in reference to them need not be performed by an individual user 20, but instead can be performed by another automated process or any other source.

As discussed in greater detail below, data values and/or statistics (actual or estimated) for the selected set (e.g., set 60A or 60B) of predictor variables 60 is mapped, using a corresponding mapping or transfer function 65A or 65B, respectively, in order to estimate data values and/or statistics for a set of factor variables 70. In the preferred embodiments of the invention, the set of factor variables 70 is standardized so that all, substantially all, or at least the majority of, the user-selected sets of predictor variables 60 are mapped to the same set of factor variables 70. Thus, in the illustrated example, both of sets 60A and 60B, even though containing different predictor variables 60, are mapped to the same set of factor variables 70, albeit using different mappings 65A and 65B, respectively.

In the preferred embodiments there prior between 12-40, more preferably 15-25, and even more preferably exactly or approximately 18, such factor variables 70. Considerations pertaining to the types of factor variables 70 to be used are discussed in the '891 patent, and the same considerations pertaining to the factor variables in the '891 patent preferably also apply to the factor variables 70 here. More preferably, the specific 18 factors identified in the '891 patent as being the preferred factor variables are used as the factor variables 70 in the present embodiments. However, other factor variables 70 instead (or in addition) may be used, such as a user-selected benchmark list.

The generated data values and/or statistics for the factor variables 70, either alone or in combination with historical data values and/or statistics for such factor variables 70, are then mapped using a mapping or transfer function 75 to estimated data values and/or statistics for a number of target variables 80. The transfer function 75 can be implemented, e.g., in any of the ways described in the '891 patent (e.g., generated based on a model using a regression technique, such as linear or nonlinear multiple regression, a genetic algorithm, a neural network technique, or any other known technique) or using any of the transfer function approaches discussed herein. Similarly, as in the '891 patent, the target variables 80 can represent, e.g., the monetary prices or values of different financial assets (e.g., stocks, commodities, mutual funds or arbitrary portfolios of different assets).

When a fixed set of factor variables 70 is used, the mapping 75 from the handful of factor variables 70 to a large number of often target variables 80 can be performed in advance and stored for use when needed. Then, when the user 20 specifies a set (e.g., 60A or 60B, respectively) of predictor variables 60 (often, a fairly small number of such predictor variables 60), just by generating the transfer function (e.g., 65A or 65B, respectively) for mapping to the factor variables 70, it can be possible to very quickly and efficiently determine the effects of those predictor variables 60 on any desired subset (e.g., 80A or 80B) of a very large number of target variables 80. Often, individual users 20 will only examine a small subset 80A or 80B of target variables 80. However, it is also common for users 20 to screen across all or very large numbers of the target variables 80, e.g., looking for assets satisfy certain user-specified criteria. As discussed in greater detail below, the information obtained for the target variables 80 can be directly used to efficiently allocate financial or other resources.

In one respect, the present invention expands beyond the approach discussed in the '891 patent by allowing users 20 to specify an arbitrary set of predictor variables 60, as well as various kinds of information regarding the specified predictor variables 60, and then obtain an estimate of the effects such values will have on specified target variables 80. It should be noted that the various forms of the terms “estimate”, as used herein, unless specifically stated otherwise, can refer to the generation of past or present data values, as well as predictions of future data values.

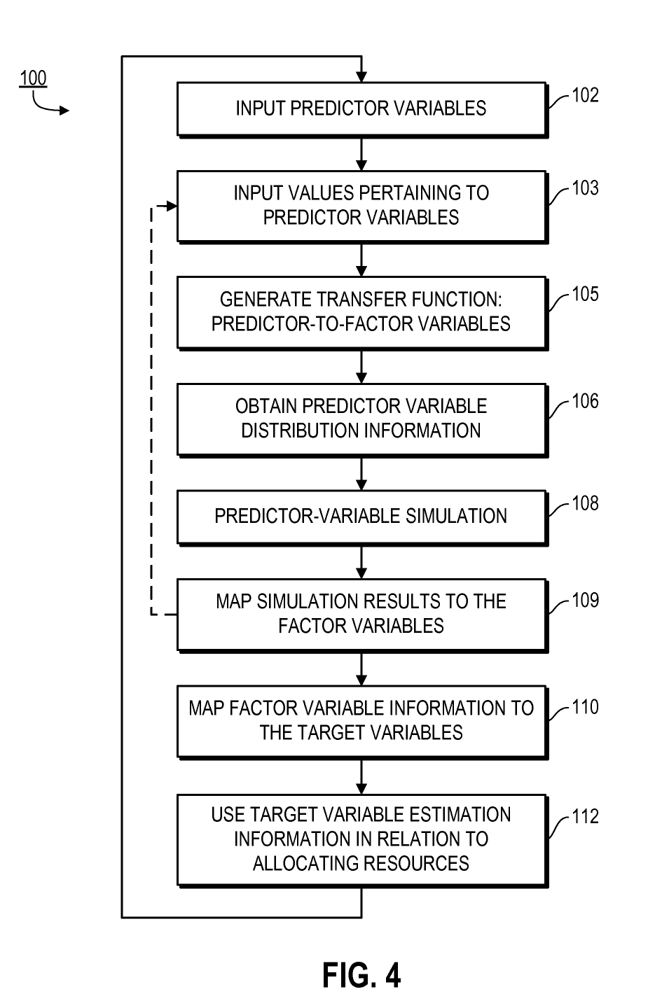

FIG. 4 is a flow diagram of a process 100 involving scenario simulation and multi-step mapping according to a representative embodiment of the present invention. Preferably, the following steps primarily are executed by the processor 35 of server 10 and, in some embodiments, partly by the processor of the user device 21 for the user 20 who is requesting results of the process 100.

Initially, in step 102 a set 60A of predictor variables 60 is input. Preferably, this step is performed by: (1) server 10 transmitting (or otherwise making available, e.g., through search queries) to the user device 21 a set of available predictor variables 60 (e.g., including at least 250, 500, 1,000, 5,000, 10,000, 50,000 or 100,000 available predictor variables 60), (2) user device 21 then displaying or providing access to the list (e.g., through a web browser or the user interface of a dedicated application), (3) user device 21 allowing the user 20 to select the desired predictor variables 60 (e.g., by searching the list and/or clicking on checkboxes associated with such predictor variables 60 and then clicking “submit” when finished), and (4) when the desired predictor variables 60 have been selected, user device 21 transmitting their identities to server 10. As noted above, the list of available predictor variables 60 preferably is made up of those variables for which server 10 has access to historical data values 11.

Alternatively, any other technique can be used to identify and/or input the predictor variables 60, such as automated selection by a different computer-executed process and/or a hybrid approach in which the predictor variables 60 are identified in part using input from the user 20 and in part by an automated process. Also, in certain embodiments the definitions of at least some of the predictor variables 60 incorporate time dependencies.

For instance, in one specific alternate embodiment, the user 20 identifies a set of measures (e.g., a specific interest rate, a specific exchange rate and the price of a specific commodity) without reference to time and then a separate automated process (e.g., running correlations at different time offsets) identifies an optimal or near-optimal time offset for each such predictor variable 60 relative to a target date for the values of the factor variables 70 (e.g., subject to any user-specified constraints), thus effectively determining an appropriate amount of “lead” or “lag” for any of such measures that are leading or lagging indicators for the set of factor variables 70. Each such predictor variable 60 preferably then is defined as the value of the user-selected measure at the time point identified by the automated process. In other embodiments, such time leads and/or lags are partially or wholly specified by the user 20. In any event, it is generally preferable for the user 20 to identify the measures themselves because it often will be the case that individual users 20 often will have different levels of comfort with respect to their abilities to estimate the values of different measures.

In step 103, values pertaining to the predictor variables 60 within the selected set 60A are input. Similar to the preceding step, the present step preferably also involves providing a user interface on the user's device 21 through which the user 20 can specify, e.g.: (1) expected or estimated data values for the predictor variables 60, e.g., with respect to predetermined future point(s) in time (such as a time point(s) determined in step 102) and/or with respect to future point(s) in time that are specified by the user 20 through the provided user interface; (2) an expected or estimated amount of change that the user 20 expects there to be in the data values for the predictor variables 60 from their current values to any of the foregoing future points in time; (3) an indication of the user's level of confidence in such estimated future data values or future data value changes (e.g., specified as: (a) a direct indication of the user's level of confidence, such as on a scale of 1-5; (b) an amount of potential variation (plus or minus); (c) “maximum” and “minimum” expected values; or (d) a standard deviation, variance or other indication of expected variation); and/or (4) the type of distribution (e.g., normal, triangular or uniform) to be used with respect to the specified values.

Examples of such user interfaces are the prediction input tools described and claimed in the '084 patent. Such input tools can be used to specify any of the values provided by the user 20, such as any of those referenced in the preceding paragraph. Alternatively, any other tool for the user 20 to input such values instead (or in addition) may be used.

More generally, any technique for any person or entity to input such values or estimates pertaining to the predictor variables 60 can be used. For example, any or all of such values can be automatically provided by a different computer-executed process (e.g., after generating such values based on other input data). In any event, once input such values preferably are provided to server 10.

In step 105, a transfer function 65 that relates data values for the predictor variables 60 to data values for the factor variables 70 is generated. Any statistical, mathematical or computer-logic technique can be used to generate this transfer function, preferably using historical data values for the predictor variables 60 and for the factor variables 70. Ordinarily, the most recent historical data over the longest duration (e.g., as determined by the user 20, server 10 and/or the administrators of server 10) that is believed to represent the economic environment of the present through the desired forecast horizon would be used. However, in alternate embodiments, the user 20, server 10 and/or the administrators of server 10 are permitted to designate one or more other historical periods that are believed to more closely match the current economic environment (e.g., where it is believed that the economy is just entering, or has just entered, a different economic environment). In any event, it is preferable to use at least twice as many historical observations as there are factor variables 70 (such as at least 30-40 days). More preferably, at least 12-36 months of historical data are used. However, as indicated above, the appropriate time period to use generally will depend upon the specific purpose for which the estimation is desired. Thus, for example, momentum traders typically will want to use the shortest time period possible, while long-term investors might want to use 10-20 years of historical data.

In one approach, multiple linear regression using the ordinary least squares (OLS) methodology is employed to estimate how the predictor variables 60 impact each of the factor variables 70. That is, a separate multiple linear regression is performed for each of the factor variables 70 across all of the predictor variables 60. One advantage of this approach is that an estimate of the explanatory power of the predictor variables 60 can be easily generated (as opposed to the degree to which the estimation is simply the mean of the factor variable over the regression period(s)).

In another approach, each of the N factor variables 70 is estimated using all of the other (N−1) factor variables 70 and all of the predictor variables 60, resulting in a system of N equations. Then, input values for the predictor variable 60 are used to generate estimations for the factor variables 70. This approach has the advantage of capturing the impact of each of the factor variables 70 on the others of the factor variables 70, thus taking into account higher-order effects.

Other approaches which can generate unique models include curve-fitting techniques, neural network techniques, nonlinear regression, systems equation estimation such as three stage least squares, and/or optimization methods to find parameters to minimize cost functions of various descriptions (such as linear programming methods). Genetic-algorithm-based techniques and similar iterative search methods (simulated annealing, for example) may also be used but they are less certain to generate unique models.

Still further, rather than directly generating the values of the factor variables 70, other approaches begin with the assumption that the economy is stable and then estimate the perturbation that would result from specified values of the predictor variables 60 (i.e., if the predictor variables 60 had the specified data values rather than their actual current values). For example, if Z(t) is the value of a factor variable 70 at time t and \hat{Z}(t) is the simulated value at time t, then \hat{Z}(t)=Z(t)+dZ(t), where dZ(t) is an equation relating the change in Z(t) to changes in the predictor variables 60. Thus, if there are no changes in the predictor variables, there would be an expectation that there are no changes in the factor variables 70. In this case, dZ(t) could be estimated at least two ways, including: (1) computing the change in the current Z(t) and the estimated Z(t) where the estimation comes from equations relating the factor variables 70 to the predictor variables 60, estimating/forecasting a level of Z, and then taking the implied difference; or (2) estimating dZ(t) directly from the equations used in the transfer function.

Each of the foregoing approaches also can be implemented using separate up-market and down-market calculations. Finally, multiple different estimation techniques can be used (such as any of the techniques referenced above), with or without estimate updates over time, and with the results of those estimates combined, e.g., using Kalman filtering.

In step 106, distribution information is obtained (e.g., input and/or generated) for the predictor variables 60. Preferably, the processing performed in this step depends upon the information that has been input (e.g., by the user 20) for the predictor variables 60 and involves the implicit or explicit specification of one or more statistical distributions for the predictor variables 60. For example, if an expected data value, a minimum data value and a maximum data value have been specified by the user 20, a standardized distribution preferably is assumed (more preferably, a triangle distribution) and is parameterized using those input values and, in some cases, historical data as well. Alternatively, if the user 20 has specified a particular type of distribution, then that distribution preferably is parameterized in a similar manner.

In some cases, estimation information provided by the user 20 (such as where the user 20 has input expected value, standard deviation, variance or minimum and maximum expected values) may be used directly. In other cases (such as where the user 20 has input a confidence level), such information preferably is converted to a usable statistical measure, such as standard deviation, variance or minimum and maximum expected values. For example, if the user 20 has input a confidence value (R) of 1-5, with 5 indicating greatest possible confidence, an estimated variance might be calculated as \hat{σ}²=k(6−R)σ_{H}², where k is a selectable scaling parameter and σ_{H}² is the historical variance of the subject predictor variable 60.

Preferably, a specific statistical distribution or just information regarding the distribution (such as variance or standard deviation) is obtained in this step 106. As noted above, such information can be directly provided (e.g., by the user 20 or otherwise input in step 103), in which case such information preferably is simply identified or tagged in this step 106, and/or can be generated or derived based on such input information and/or based on historical information for the predictor variables 60.

In certain embodiments, the processing in this step 106 uses default information, e.g., as to type of distribution and distribution parameters, preferably having been obtained through an analysis of the historical data of the predictor variables 60, but replaces or supersedes that information with any similar information that has been supplied by the user 20 and/or that has been derived from information supplied by the user 20. In others, the information input in step 103 and historical information are used together.

More generally, in each of the steps described herein, such historically based default assumptions preferably are used except to the extent similar information is provided by or derived from the user 20 (or other input source), in which case the default assumptions can be superseded by such information, modified by such information, or combined with such information in an attempt to generate better information than either alone would provide (e.g., using the techniques described herein).

In certain embodiments, the predictor variables 60 are assumed to be independent of each other. However, in other embodiments historical data for the predictor variables 60 are processed (e.g., over the same time period(s) used in step 105) to generate covariances, joint distributions, or other estimates of the statistical dependencies among the predictor variables 60. In still further embodiments, a regime-based covariance model is generated, e.g., using predefined regime definitions or using clusterization to identify and distinguish different regimes.

In step 108, a simulation is performed across the predictor variables 60. Preferably, a Monte Carlo simulation is performed using 5,000-20,000 (and, more preferably, approximately 10,000) iterations, with different random draws for data values of the predictor variables 60, based on the distributions for the predictor variables 60 that were obtained in step 106. A precalculated set of random variates can be used to drive all of the other random variables (e.g., one general set of random draws which would impose a common factor on all the random predictor variables 60) or a set of independent random draws can be used. In one specific embodiment, this step results in a random matrix, where each column contains 10,000 observations (or any other chosen number of iterations) of the independently drawn random variable for the predictor variable 60 that is associated with the given column.

As noted above, triangle distributions preferably are assumed for the predictor variables 60. Such distributions can be computed, e.g., from the minimum, maximum, and most likely estimations input in step 103, or from similar parameters that have been adjusted by user confidence and/or covariance, and from a uniform distribution random number generator (e.g., generating numbers between 0 and 1). For example, if the random number generator provides a number below a given a “determination value” equal to (c−a)/(b−a), where a and b are the estimated minimum and maximum values, and c is the estimated most-likely value, the ‘triangle distributed’ random number would be equal to a+\sqrt{U(b−a)(c−a)}, where U is the original generated random number; and if the random number generator provides a number greater than or equal to the “determination value” noted above, the ‘triangle distributed’ random number is equal to b−\sqrt{(1−U)(b−a)(b−c)}.

In addition, in certain embodiments the historical correlation matrix on the predictor variables 60 is used to convert the distributions (e.g., triangle distributions) for the predictor variables 60 into multivariate distributed variables. One approach uses the technique described by Philip M. Lurie and Matthew S. Goldberg, “An Approximate Method for Sampling Correlated Random Variables from Partially-Specified Distributions”, Management Science, vol. 44, No. 2, February 1998, pp. 203-218. This technique (based on the research of Li and Hammond “Generation of Pseudo-Random Numbers With Specified Univariate Distributions and Correlation Coefficients”, IEEE Trans. On Systems, Man, and Cybernetics, 5 (1975), 557-561) takes a set of independent and identically distributed (i.i.d) random variables with standard normal distribution and transforms that set into a set of random variables with the desired distribution and approximately the desired correlation.

In certain embodiments, a “mixture of distributions” is used in which a fully diffused prior (or default) distribution (based solely on historical data for the predictor variables 60) is combined with the specified distribution (based solely on the values input in step 103). One such approach is to use a “weighted distribution” formed by combining the specified distribution with the fully diffused prior distribution, e.g., where the weight placed on the specified distribution as compared to the weight placed on the default distribution is based on the degree(s) of confidence expressed by the user 20 (or other entity) in the data value estimates submitted in step 103. For example, if confidence in a data value input in step 103 for a particular predictor variable 60 is expressed as a percentage C, the weight on the specified distribution might be set equal to C, while the weight on the default distribution is set equal to 1−C.

In step 109, the simulation results generated in step 108 for the predictor variable 60 are transferred (or mapped) to the factor variables 70 (e.g., to obtain simulated values for the predictor variables 70) using the transfer function generated in step 105. Preferably, each set of data values for the predictor variables 60 is mapped to a corresponding set of data values for the factor variables 70 and then these data values for the factor variables 70 are processed to generate statistical information for each such predictor variable 70, such as expected value, standard deviation or variance, type of distribution, co-variances, etc. Any or all of these statistics and/or histograms for the factor variables 70 may be displayed to the user 20, e.g., to provide the user 20 with a general sense of how the estimates provided in step 103 are likely to affect general economic variables and/or to allow the user to reconsider those estimates and, potentially, return to step 103 in order to revise them.

In step 110, the data values and/or statistics for the factor variables 70 are mapped using transfer function 75 to estimates for some (e.g., selected ones) or all of the target variables 80. This step can be performed, e.g., using any of the techniques described in the '891 patent. As noted above, the mapping functions 75 preferably have been precomputed and are used, among other things, to obtain estimates of the target variables 80 based on direct estimates of the factor variables 70. However, in the present embodiment, rather than obtaining direct estimates for the factor variables 70, the estimates and statistics obtained in step 109 are used in this step 110. Of course, some or all of the factor variables 70 could have been selected as predictor variables 60 in step 102.

The result of this step 110 can include just estimates for the data values of the target variables 80 or can also include distributions, histograms, other statistical summaries and/or predictive statistics, such as the amount of expected variation in the data values of such target variables 80, any of the statistics included in the MacroRisk.com, DualBeta.com, and/or EconomicInvestor.com websites, or any of the statistics mentioned in any of the patents incorporated by reference herein. If a mutually exclusive categorization is used (e.g., the Economic Climate Rating or “MacroRisk Stars” which is a 5 item mutually exclusive qualitative rating on MacroRisk.com), then such a categorization can be computed with each iteration, and the overall probability of the Target Variables being in each category can be presented. For example, in one representative embodiment, the percentage probabilities that a particular asset or portfolio (represented by one or more of the target variables 80) would be expected to have a 1-star, 2-star, . . . , 5-star rating, given the estimate(s) input in step 103, are calculated. In this regard, the exclusive categorization can be based on percentile or decile groupings for one or more selected quantitative measures.

In step 112, the statistics for the target variables 80 that were generated in step 110 are displayed to the user 20 and/or used to suggest transactions to the user 20 or to automatically effect transactions. For example, one or more assets may be purchased or sold based at least in part on the information provided by step 110. The specific actions taken in this step 112 often will be relatively straightforward based on the information provided by step 110. For example, if the information provided by step 110 indicates that the price of a particular asset is likely to rise, then: the asset may be purchased, an option on the asset may be purchased, or any other derivative instrument whose value increases based on an increase in the underlying subject asset may be purchased, with the specific action taken, e.g., either being selected by the user 20 or being selected automatically based on previous preferences selected by the user 20. Also, in certain embodiments, any of the foregoing actions may be based on additional information, such as only buying/selling or recommending a buy/sell if the estimated price of an asset corresponding to a particular target variable 80 has a specified minimum/maximum value and the estimated variability in such price is less than a specified threshold.

In addition to directly using the information generated in step 110, such information can be passed to another automated process. For example, such information (e.g., for all covered or available target variables 80) may be made available to a screening tool, so that the user 20 can search for and find the best opportunities available (e.g. assets that are estimated to have the greatest increase or decrease in price or value, subject to other criteria such as limited overall riskiness or limited riskiness with respect to specified ones of the factor variables 70) given the scenario he or she has input. One specific use of such as screening tool is for the user 20 to identify which of the values determined for the target variables 80 are likely to have the highest level of confidence, thus allowing the user 20 to determine the real-world effects that the input estimates are most likely to have. Of course, similar screenings also can be used for effecting automated buy, sell and other transactions.

The foregoing process 100 preferably is repeated a number of times (e.g., at least 50, 100, 500, 1,000, 5,000 or 10,000 times) using the same set of factor variables 70 and transfer functions 75, with only the predictor variables 60 and/or the values for those predictor variables 60 changing from repetition to repetition. More preferably, the transfer functions 75 preferably are generated independently of the transfer functions 65. As a result, significant efficiencies can be obtained because at each repetition it mainly is necessary to generate the mapping function 65 for a relatively small number of predictor variables 60 to another relatively small number of factor variables 70, while at the same time allowing data-value and statistical estimates regarding a very large number of target variables 80 to be generated based on whatever estimates are available, from any of a very large number of possible predictor variables 60. In other words, the techniques of the present invention often can extract the maximum amount of value possible from the information that is available to any given individual or entity.

More specifically, by using the present two-stage approach, it is not necessary to keep re-estimating equations for the target variables 80 (which typically will be more than 1,000, 10,000, 50,000, or even 100,000). Instead, by periodically generating “file copies” of the transfer functions 75, and then estimating the transfer functions 65 as needed, this part of the overall computation becomes very efficient, which can be particularly important when performing a high-quality simulation. Moreover, when this technique is coupled with the use of pre-calculated random terms, substantial computational time savings are provided.

In addition to allowing users 20 (or any other individual, entity or automated process that selects the predictor variables in step 102 and/or provides estimates for them in step 103) to provide data-value estimates for large number of predictor variables 60, process 100 preferably permits the specification of a level of confidence in those estimates. As result, even more accurate information regarding the target variables 80 can be generated, again, based on the best information that is available at the time. Even with the provided efficiencies, process 100 generally can determine the simultaneous impact of the input predictor variable estimates on a wide range of factor variables 80.

As indicated above, the foregoing process 100 can be used in a variety of different ways. Most often, they will be used to obtain predictions (i.e., estimates of future values) for one or more asset prices or values or any other measures (i.e., where one or more of the target variables 80 correspond to the future value of some measure). However, they can also be used to obtain better estimates of current or even past data values for certain measures which, e.g., can then be used in conjunction with the present and/or other techniques to obtain estimates of future data values for other measures.

One specific use of the simulation results from the foregoing techniques is to forecast a Sharpe Ratio and/or other metrics for a specified portfolio. In addition, or instead, such results can be used to optimize a portfolio, e.g., to maximize the Sharpe Ratio or to optimize based on any other objective function, such as to minimize the Composite MacroRisk Index (CMRI), maximize the Sortino ratio, etc. As discussed, e.g., in the '891 patent, the ETA profiles for different assets can be combined so as to minimize overall risk, which is particularly useful for creating a portfolio of assets having high projected returns.

Another specific use is to include a step to estimate option parameters, or parameters for other derivative instruments, based on the simulation results and then use those parameters to calculate an appropriate price for the derivative. Then, for example, a step preferably also is included to automatically purchase a derivative, or at least automatically recommend that it be purchased, if the derivative is being offered at a price that is lower than the calculated price.

### Resource Management Control Using Attribution-Based Processing.

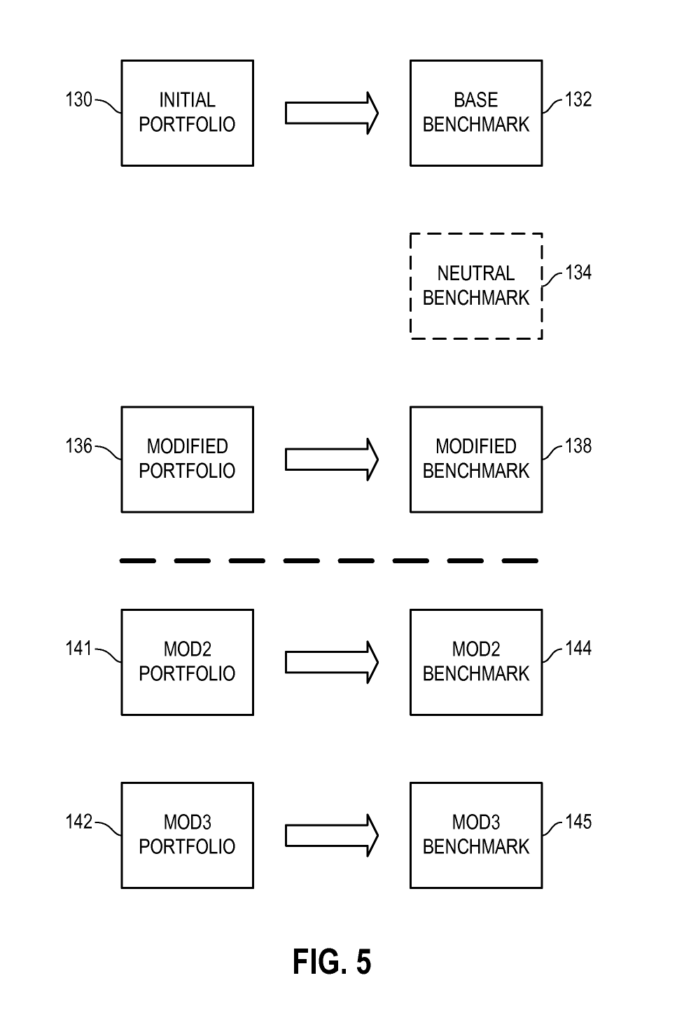

FIG. 5 is a block diagram illustrating certain components of attribution analysis, beginning with an initial portfolio 130 of assets. Generally speaking, there are at least two scenarios for which the present techniques may be performed. In one such scenario, only two time points are considered, the date and corresponding composition of the initial portfolio 130 and a later “evaluation date” at which that initial portfolio 130 has been modified (e.g., through a variety of different purchases and sales) and thus exists as a somewhat different portfolio 136. In another scenario, the portfolio is evaluated at multiple points in time in order to obtain ongoing and often more-detailed data about how it is being managed. In this case, additional modified versions of the portfolio (e.g., portfolio modifications 141 and 142) are obtained, and each is evaluated relative to one or more previous versions of the portfolio, e.g., in comparison to certain benchmark portfolios, as discussed in greater detail below.

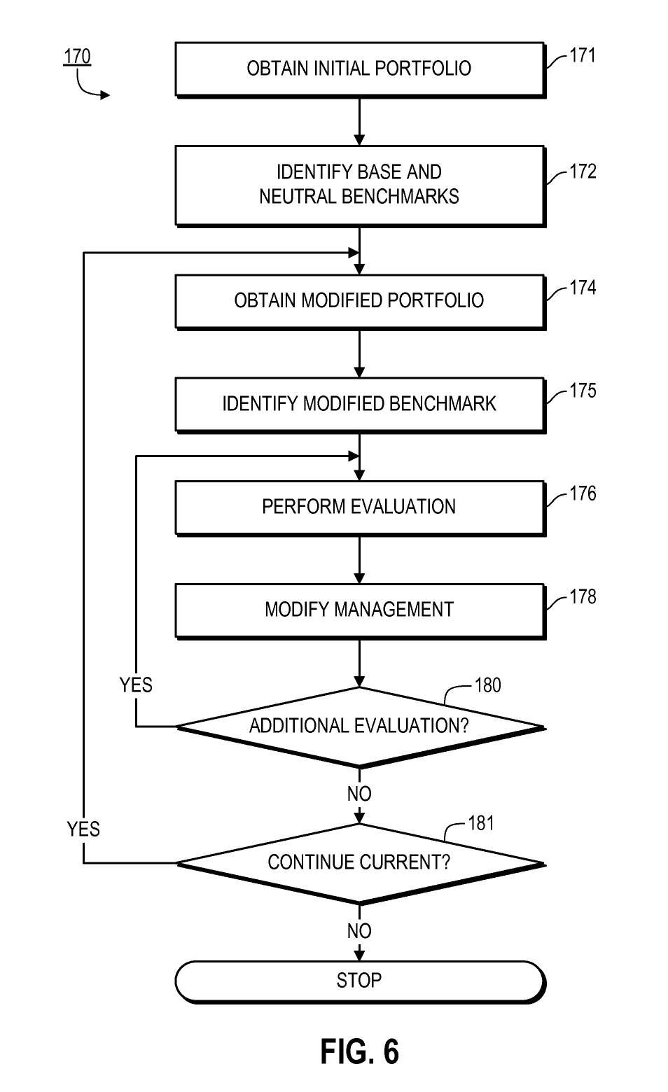

FIG. 6 illustrates a process 170 for controlling resource management using attribution analysis according to certain representative embodiments of the present invention. Preferably, process 170 is executed by server 10, either alone or in combination with (e.g., by offloading some processing to) user device 21.

Initially, in step 171 the composition of the initial portfolio 130 is obtained. Ordinarily, portfolio 130 (and each of the portfolios mentioned herein) will include publicly traded assets, or at least assets for which a market price is readily available, together with a quantity for each such asset. The initial portfolio 130 preferably is defined as the composition a specified existing portfolio as of a specified date, e.g., the date that a new manager assumes management of the portfolio or the date that a new management approach is initiated.

In step 172, a base benchmark 132 and a neutral benchmark 134 are identified. Both of such benchmarks 132 and 134 preferably are portfolios made up of the same assets and/or indexes, but typically with different weightings on such assets and/or indexes. In the preferred embodiments, this set of assets and/or indexes is sufficiently diverse to be able to closely replicate the performance (e.g., in terms of return and risk profiles) of all of the assets and/or asset classes that currently are included within the portfolio 130 and/or that potentially might be included within it in the future. The assets and/or indexes within the neutral benchmark 134 can be weighted in any of a variety of different ways, e.g., using equal weightings, fundamental indexing weighting, Fama-French three-factor weightings, or any other weighting approach. The weightings for base benchmark 132 preferably are selected such that base benchmark 132 tracks initial portfolio 130 with regard to a specified risk profile. More preferably, any of the techniques disclosed and/or claimed in the '219 patent are used for establishing the weightings on the assets and/or indexes within base benchmark 132.

In step 174, a modified portfolio (e.g., portfolio 136 in the first iteration of this step) is obtained. This modified portfolio is the result of changes to the previous version of the portfolio (e.g., initial portfolio 130 in the first iteration), including one or more purchases into and/or sales out of initial portfolio 130. Depending upon the particular embodiment and/or user-specified settings, the modified portfolio might, e.g., be the state of the portfolio: after a fixed period of time (e.g., three months, six months, one year, two years, three years or five years); after any asset purchase or sale; after any individual asset purchase or sale that exceeds a specified amount (e.g., at least 0.1%, 0.25%, 0.5%, 1%, 2% or 3% of the aggregate value of the portfolio), or any combination of purchases and/or sales that exceeds such specified amount; or at any time an oversight entity wants to evaluate management performance.

In step 175, a modified benchmark (e.g., benchmark 138) is identified based on the modified portfolio obtained in the immediately preceding iteration of step 174. Preferably, the modified benchmark includes the same assets/indexes as base benchmark 132 and neutral benchmark 134, but with weightings determined based on the composition of the modified portfolio obtained in step 174. More preferably, the same tracking methodology used in step 172 is used in this step 175.

In step 176, an evaluation is performed, preferably by evaluating information as of an “evaluation date”, typically a date corresponding to the modified portfolio obtained in step 174 (e.g., the earliest date that the portfolio qualified as the modified portfolio 136) in relation to information as of a “reference date” (e.g., in the first iteration of process 170, a date corresponding to the initial portfolio 130 or, in subsequent iterations, any designated earlier version of the portfolio). For this purpose, a variety of different metrics, such as returns, excess returns, risk, risk-adjusted returns (e.g., Sharpe ratios or any other risk-normalized returns), or any other statistics mentioned herein (either explicitly or through incorporation by reference), preferably are calculated then compared. However, returns-based metrics alone or risk-adjusted returns-based metrics often will provide the most meaningful information.

In the preferred embodiments, comparison estimates are then generated, with each such comparison estimate comparing the portfolio to a benchmark or comparing one benchmark to another in relation to one or more of such metrics. Such comparison estimates can be defined as differences, ratios or any function using differences and/or ratios of the underlying (or compared) metrics.

If a fairly large number of transactions have occurred in the portfolio between the reference date and the evaluation dated (generally corresponding to the first scenario mentioned above), the following comments apply. Any such comparison between the benchmark established as of the reference date (e.g., the base benchmark 132) and the neutral benchmark 134, e.g., with respect to the changes from the reference date to the evaluation date, provides a measure of the impact of the reference-date (e.g., initial) asset allocation. Any such comparison between the evaluation-date benchmark (e.g., benchmark 138) and the reference-date benchmark (e.g., the base benchmark 132), e.g., with respect to the changes from the reference date to the evaluation date, provides a measure of the impact of changing the asset allocation (as represented by the index weights) over time (as opposed to changes in specific assets), which is referred to herein as the Asset Allocation Component. Any such comparison between the portfolio as dynamically revised and the reference-date benchmark (e.g., the base benchmark 132), e.g., with respect to the changes from the reference date to the evaluation date, provides a measure of the impacts of the changes in asset-class allocation and individual asset selection; then, the difference between this comparison estimate and the Asset Allocation Component reflects the impact of individual asset selection, referred to herein as the Asset Selection Component.

In addition to calculating metrics and performing comparisons over two points in time, in the second scenario mentioned above, where portfolios have been obtained and corresponding benchmarks identified at multiple points in time, other and/or additional processing can be performed in this step 176. For instance, if a modified portfolio is obtained each time a transaction (e.g., purchase or sale) occurs within the portfolio, the following comments apply. The difference in the portfolio's performance between such modifications (e.g., the performance of modified portfolio 136 from its creation date to just before the creation of modified portfolio 141) relative to the corresponding periodic benchmark (e.g., the performance of modified benchmark 138 from its creation date [which also is the creation date of portfolio 136] to just before the creation of modified benchmark 144 [which also is the date the modified portfolio 141 was created]) is a measure of the asset selection. The cumulative difference in the benchmark's chained performance (e.g., including the cumulative performances of modified benchmark 138, modified benchmark 144 and modified benchmark 145 during their respective periods of existence) relative to the base benchmark 132 (during the same aggregate period of time) is a measure of the ongoing benefit from revising asset allocation (as opposed to selection of individual assets). The performance of the portfolio over time versus the chained performance of the dynamic benchmarks (e.g., as in the preceding sentence) is a measure of the success or failure of individual asset selection. The performance and characteristics of the changing portfolio over time, chained, versus the corresponding performance and characteristics of the original portfolio is another measure of “gain from active management”.

In step 178, any changes in management indicated by the evaluation in step 176 are performed. The performance of this step can take a variety of different forms, depending upon the entities that are involved in performing the step, but typically would involve: adjusting compensation for existing management, transferring management of assets to or away from the current manager, replacing the current manager, and/or finding a manager for currently unmanaged assets. As noted above, the processing performed in step 176 can evaluate, e.g., a manager's overall success or failure in actively managing the assets under his or her control, as well as separately evaluating the manager's success or failure in selecting asset classes and in selecting individual assets. Management compensation can be automatically based on a specified function of any or all of these estimates. In addition, analysis of such estimates, particularly in comparison to corresponding estimates for a number of different managers, can be used, e.g., to automatically (or even manually based on one or more graphical displays of such comparison data) transfer individual assets, asset classes and/or responsibilities for managing certain kinds of assets among managers in order to ensure that the manager with the greatest expertise in each asset class and/or individual asset is in fact managing such asset class or individual asset, thereby achieving greater overall efficiency. In some cases, e.g., based on prespecified criteria in relation to such comparison estimates, an existing manager either will be automatically replaced or will be recommended for replacement.

It is noted that the foregoing techniques for adjusting compensation and/or reallocating responsibilities can be used, e.g., both by institutional investors and by individual investors. In addition, an individual investor who currently is managing his or her own assets might find it apparent, based on the information presented in step 176, that he or she would be better off finding a professional manager or even (e.g., in the case of negative values for the subject comparison estimates) placing his or her assets into a fully diversified index fund (i.e., no active management at all). Similarly, an individual investor who is not currently using active management, upon reviewing recent results for available managers, might determine that there are significant gains to be realized by transferring responsibility for his/her assets to a particular manager.

Referring again to FIG. 6, in step 180, a determination is made as to whether any additional evaluation is desired. For the one-time evaluation scenario mentioned above, the determination would be “no” and processing would proceed to step 181. For the ongoing evaluation scenario, in addition to reviewing the effects of individual transactions or other incremental changes to the portfolio, it periodically might be desirable to evaluate results over longer and/or different periods of time. If so, processing returns to step 176 to perform such additional evaluation.

In step 181, a determination is made as to whether the current analysis is to be maintained. Once again, for the one-time evaluation scenario mentioned above, the determination would be “no” and processing would conclude. Ordinarily, for the ongoing evaluation scenario, the determination would be “yes” and processing would return to step 174 to obtain the next modified portfolio. However, at some point, such as a change in manager or a change in the management approach, the current analysis would be concluded and, typically, a new instantiation of process 170 would be begun, e.g., using the current portfolio as the new initial portfolio 130 (i.e., as a new baseline).

As will be readily appreciated, attribution analysis according to the present invention generally does not require pre-specifying specific indexes to be associated with each group, does not require knowing exact holding of portfolios or funds, and is not dominated by short-term returns. The result is a flexible approach to understanding the contribution of management to a portfolio or fund's returns and an effective custom benchmark for assessing fund performance.

In the foregoing embodiments, asset management is controlled using attribution-based analysis. However, such analysis also can be used to optimize portfolios of assets, either on a backward-looking or on a forward-looking basis. With respect to the former one approach is as follows: beginning with a benchmark, calculate any or all of the foregoing metrics over a specified period of time; then iteratively adjust the weightings in view of the comparison estimates so as to obtain an optimal portfolio (e.g., in terms of return, risk-adjusted return, or any other desired statistic(s) or metric(s)). With respect to the latter, one approach is as follows: using an input “what-if” scenario, perform scenario simulation with multi-step mapping (as discussed in the preceding section) to simulate a future environment; then, the foregoing attribution analysis is performed with the present conditions being used for the reference date and the simulated future conditions being used for the evaluation date; finally, the weightings on the assets in a starting benchmark are adjusted so as to obtain an optimal portfolio (e.g., as noted in the preceding sentence).

Still further, the attribution analysis of the present section can be used in conjunction with the simulation and multi-step mapping of the previous section in order to further analyze the expected results of an input “what-if” scenario on an existing portfolio. In one example: a base benchmark 132 and a neutral benchmark 134 are generated for the existing portfolio; the simulation of the preceding section is run based on the input “what-if” scenario; and the performances, above-referenced metrics and other characteristics of the portfolio, base benchmark 132 and neutral benchmark 134 are compared against each other in order to identify, e.g., the effects of asset classes in the portfolio, the effects of individual assets in the portfolio, and the expected changes in the risk profile as a result of holding the portfolio, all under the assumption of the input “what-if” scenario.

### System Environment.

Generally speaking, except where clearly indicated otherwise, all of the systems, methods, functionality and techniques described herein can be practiced with the use of one or more programmable general-purpose computing devices. Such devices (e.g., including any of the electronic devices mentioned herein) typically will include, for example, at least some of the following components coupled to each other, e.g., via a common bus: (1) one or more central processing units (CPUs); (2) read-only memory (ROM); (3) random access memory (RAM); (4) input/output software and circuitry for interfacing with other devices (e.g., using a hardwired connection, such as a serial port, a parallel port, a USB connection or a FireWire connection, or using a wireless protocol, such as radio-frequency identification (RFID), any other near-field communication (NFC) protocol, Bluetooth or a 802.11 protocol); (5) software and circuitry for connecting to one or more networks, e.g., using a hardwired connection such as an Ethernet card or a wireless protocol, such as code division multiple access (CDMA), global system for mobile communications (GSM), Bluetooth, a 802.11 protocol, or any other cellular-based or non-cellular-based system, which networks, in turn, in many embodiments of the invention, connect to the Internet or to any other networks; (6) a display (such as a cathode ray tube display, a liquid crystal display, an organic light-emitting display, a polymeric light-emitting display or any other thin-film display); (7) other output devices (such as one or more speakers, a headphone set and/or a printer); (8) one or more input devices (such as a mouse, touchpad, tablet, touch-sensitive display or other pointing device, a keyboard, a keypad, a microphone and/or a scanner); (9) a mass storage unit (such as a hard disk drive or a solid-state drive); (10) a real-time clock; (11) a removable storage read/write device (such as a flash drive, any other portable drive that utilizes semiconductor memory, a magnetic disk, a magnetic tape, an opto-magnetic disk, an optical disk, or the like); and/or (12) a modem (e.g., for sending faxes or for connecting to the Internet or to any other computer network). In operation, the process steps to implement the above methods and functionality, to the extent performed by such a general-purpose computer, typically initially are stored in mass storage (e.g., a hard disk or solid-state drive), are downloaded into RAM, and then are executed by the CPU out of RAM. However, in some cases the process steps initially are stored in RAM or ROM and/or are directly executed out of mass storage.

Suitable general-purpose programmable devices for use in implementing the present invention may be obtained from various vendors. In the various embodiments, different types of devices are used depending upon the size and complexity of the tasks. Such devices can include, e.g., mainframe computers, multiprocessor computers, one or more server boxes, workstations, personal (e.g., desktop, laptop, tablet or slate) computers and/or even smaller computers, such as personal digital assistants (PDAs), wireless telephones (e.g., smartphones) or any other programmable appliance or device, whether stand-alone, hard-wired into a network or wirelessly connected to a network.

In addition, although general-purpose programmable devices have been described above, in alternate embodiments one or more special-purpose processors or computers instead (or in addition) are used. In general, it should be noted that, except as expressly noted otherwise, any of the functionality described above can be implemented by a general-purpose processor executing software and/or firmware, by dedicated (e.g., logic-based) hardware, or any combination of these approaches, with the particular implementation being selected based on known engineering tradeoffs. More specifically, where any process and/or functionality described above is implemented in a fixed, predetermined and/or logical manner, it can be accomplished by a processor executing programming (e.g., software or firmware), an appropriate arrangement of logic components (hardware), or any combination of the two, as will be readily appreciated by those skilled in the art. In other words, it is well-understood how to convert logical and/or arithmetic operations into instructions for performing such operations within a processor and/or into logic gate configurations for performing such operations; in fact, compilers typically are available for both kinds of conversions.

It should be understood that the present invention also relates to machine-readable tangible (or non-transitory) media on which are stored software or firmware program instructions (i.e., computer-executable process instructions) for performing the methods and functionality of this invention. Such media include, by way of example, magnetic disks, magnetic tape, optically readable media such as CDs and DVDs, or semiconductor memory such as various types of memory cards, USB flash memory devices, solid-state drives, etc. In each case, the medium may take the form of a portable item such as a miniature disk drive or a small disk, diskette, cassette, cartridge, card, stick etc., or it may take the form of a relatively larger or less-mobile item such as a hard disk drive, ROM or RAM provided in a computer or other device. As used herein, unless clearly noted otherwise, references to computer-executable process steps stored on a computer-readable or machine-readable medium are intended to encompass situations in which such process steps are stored on a single medium, as well as situations in which such process steps are stored across multiple media.

The foregoing description primarily emphasizes electronic computers and devices. However, it should be understood that any other computing or other type of device instead may be used, such as a device utilizing any combination of electronic, optical, biological and chemical processing that is capable of performing basic logical and/or arithmetic operations.

In addition, where the present disclosure refers to a processor, computer, server, server device, computer-readable medium or other storage device, client device, or any other kind of apparatus or device, such references should be understood as encompassing the use of plural such processors, computers, servers, server devices, computer-readable media or other storage devices, client devices, or any other such apparatuses or devices, except to the extent clearly indicated otherwise. For instance, a server generally can (and often will) be implemented using a single device or a cluster of server devices (either local or geographically dispersed), e.g., with appropriate load balancing. Similarly, a server device and a client device often will cooperate in executing the process steps of a complete method, e.g., with each such device having its own storage device(s) storing a portion of such process steps and its own processor(s) executing those process steps.

As used herein, the term “coupled”, or any other form of the word, is intended to mean either directly connected or connected through one or more other elements or processing blocks.

### Additional Considerations.

In the event of any conflict or inconsistency between the disclosure explicitly set forth herein or in the attached drawings, on the one hand, and any materials incorporated by reference herein, on the other, the present disclosure shall take precedence. In the event of any conflict or inconsistency between the disclosures of any applications or patents incorporated by reference herein, the more recently filed disclosure shall take precedence.

In certain instances, the foregoing description refers to clicking or double-clicking on user-interface buttons, dragging user-interface items, or otherwise entering commands or information via a particular user-interface mechanism and/or in a particular manner. All of such references are intended to be exemplary only, it being understood that the present invention encompasses entry of the corresponding commands or information by a user in any other manner using the same or any other user-interface mechanism. In addition, or instead, such commands or information may be input by an automated (e.g., computer-executed) process.

In the above discussion, certain methods are explained by breaking them down into steps listed in a particular order. However, it should be noted that in each such case, except to the extent clearly indicated to the contrary or mandated by practical considerations (such as where the results from one step are necessary to perform another), the indicated order is not critical but, instead, that the described steps can be reordered and/or two or more of such steps can be performed concurrently.

References herein to a “criterion”, “multiple criteria”, “condition”, “conditions” or similar words which are intended to trigger, limit, filter or otherwise affect processing steps, other actions, the subjects of processing steps or actions, or any other activity or data, are intended to mean “one or more”, irrespective of whether the singular or the plural form has been used. For instance, any criterion or condition can include any combination (e.g., Boolean combination) of actions, events and/or occurrences (i.e., a multi-part criterion or condition).

In the discussions above, the words “include”, “includes”, “including”, and all other forms of the word should not be understood as limiting, but rather any specific items following such words should be understood as being merely exemplary.

Several different embodiments of the present invention are described above, with each such embodiment described as including certain features. However, it is intended that the features described in connection with the discussion of any single embodiment are not limited to that embodiment but may be included and/or arranged in various combinations in any of the other embodiments as well, as will be understood by those skilled in the art.

Similarly, in the discussion above, functionality sometimes is ascribed to a particular module or component. However, functionality generally may be redistributed as desired among any different modules or components, in some cases completely obviating the need for a particular component or module and/or requiring the addition of new components or modules. The precise distribution of functionality preferably is made according to known engineering tradeoffs, with reference to the specific embodiment of the invention, as will be understood by those skilled in the art.

Thus, although the present invention has been described in detail with regard to the exemplary embodiments thereof and accompanying drawings, it should be apparent to those skilled in the art that various adaptations and modifications of the present invention may be accomplished without departing from the spirit and the scope of the invention. Accordingly, the invention is not limited to the precise embodiments shown in the drawings and described above. Rather, it is intended that all such variations not departing from the spirit of the invention be considered as within the scope thereof as limited solely by the claims appended hereto.

1. A system for facilitating allocation of resources based on available data estimates, said system comprising:
a processor for executing stored computer-executable process steps; and
a data storage device coupled to the processor and storing said process steps, said process steps including steps to:
(a) input a set of first variables;
(b) input data values pertaining to said first variables, including estimated values for the first variables;
(c) generate a first transfer function that maps values for said first variables to values for a predefined set of factor variables, based on historical values for the first variables and historical values for the factor variables;
(d) generate distribution information for the first variables based on the input data values;
(e) conduct a simulation using the distribution information for the first variables in order to obtain simulated values for the first variables;
(f) map the simulated values for the first variables to information regarding the factor variables, using the first transfer function;
(g) map said information regarding the factor variables to estimation information for a set of target variables using a second transfer function; and
(h) at least one of directly display the estimation information, use the estimation information to recommend at least one of a purchase or sale of an asset, or directly purchase or sell an asset based on the estimation information.

2. A system according to claim 1, wherein said process steps further include a step to perform a number of repetitions of steps (a)-(h) for each of a plurality of different sets of first variables and a plurality of different input data values pertaining to said first variables, but using the same factor variables for each said repetition.

3. A system according to claim 2, wherein the second transfer function has been determined in advance and is used for each said repetition.

4. A system according to claim 3, wherein the number of said repetitions is at least 50.

5. A system according to claim 1, wherein each of the first variables, the factor variables and the target variables comprises at least one of a financial or economic variable.

6. A system according to claim 1, wherein said step (h) comprises at least one of recommending a purchase or sale of an asset or directly purchasing or selling an asset.

7. A system according to claim 1, wherein said step (h) comprises directly purchasing or selling an asset.

8. A system according to claim 1, wherein said input data values pertaining to said first variables include a value representing a level of confidence in at least one of said estimated values for the first variables.

9. A system according to claim 8, wherein said value representing a level of confidence is used in generating the distribution information.

10. A system according to claim 8, wherein said value representing a level of confidence is used in said simulation.

11. A system according to claim 1, wherein the set of first variables is selected from a second set that includes at least 500 potential first variables.

12. A system according to claim 1, wherein the set of target variables includes at least 1,000 target variables.

13. A system according to claim 1, wherein the set of target variables includes at least 10,000 target variables.

14. A system according to claim 1, wherein the predefined set of factor variables includes at least 15 and not more than 25 factor variables.

15. A system according to claim 1, wherein the simulation comprises a Monte Carlo simulation.

16. A system according to claim 1, wherein generation of the distribution information for the first variables also is based on historical data for said first variables.

17. A system according to claim 1, wherein the distribution information for the first variables includes a calculated estimate of a statistical relationship between at least two of the first variables, based on historical data for said at least two of the first variables.

18. A method of facilitating allocation of resources based on available data estimates, said method comprising steps to:
(a) input a set of first variables;
(b) input data values pertaining to said first variables, including estimated values for the first variables;
(c) generate a first transfer function that maps values for said first variables to values for a predefined set of factor variables, based on historical values for the first variables and historical values for the factor variables;
(d) generate distribution information for the first variables based on the input data values;
(e) conduct a simulation using the distribution information for the first variables in order to obtain simulated values for the first variables;
(f) map the simulated values for the first variables to information regarding the factor variables, using the first transfer function;
(g) map said information regarding the factor variables to estimation information for a set of target variables using a second transfer function; and
(h) at least one of directly display the estimation information, use the estimation information to recommend at least one of a purchase or sale of an asset, or directly purchase or sell an asset based on the estimation information.

19. A tangible computer-readable medium storing computer-executable process steps for facilitating allocation of resources based on available data estimates, said process steps comprising steps to:
(a) input a set of first variables;
(b) input data values pertaining to said first variables, including estimated values for the first variables;
(c) generate a first transfer function that maps values for said first variables to values for a predefined set of factor variables, based on historical values for the first variables and historical values for the factor variables;
(d) generate distribution information for the first variables based on the input data values;
(e) conduct a simulation using the distribution information for the first variables in order to obtain simulated values for the first variables;
(f) map the simulated values for the first variables to information regarding the factor variables, using the first transfer function;
(g) map said information regarding the factor variables to estimation information for a set of target variables using a second transfer function; and
(h) at least one of directly display the estimation information, use the estimation information to recommend at least one of a purchase or sale of an asset, or directly purchase or sell an asset based on the estimation information.
